(19) United States
(12) Patent Application Publication
(10) Pub. No.: US 2009/0126396 A1
(43) Pub. Date: May 21, 2009

(54) OUT DOOR FOR REFRIGERATOR AND METHOD OF MANUFACTURING THE SAME

(76) Inventor: Ja-Hun Koo, Gyeongsangnam-do (KR)

Correspondence Address: BIRCH STEWART KOLASCH & BIRCH, PO BOX 747, FALLS CHURCH, VA, 22040-0747, US

(21) Appl. No.: 12/302,789

(22) PCT Filed: Jun. 13, 2007
(86) PCT No.: PCT/KR2007/002835

§ 371 Date: Nov. 26, 2008

(30) Foreign Application Priority Data
Jun. 21, 2006 (KR) 10-2006-0056108

(51) Int. Cl. F25D 23/02; B23P 15/26

(52) U.S. Cl. 62/449; 29/890.035

(57) ABSTRACT

The present invention relates to an outer door for a refrigerator and a method of manufacturing the same. An outer door of the present invention comprises a base plate 51 with a certain pattern 51 a formed on a front surface thereof, a back surface coating layer 53 provided on a back surface of the base plate 51, a back surface painting layer 55 provided on a surface of the back surface coating layer, and a front surface painting layer 57 provided on the front surface of the base plate 51. According to the present invention, more various designs can be implemented on a front surface of a door of a refrigerator so as to satisfy a variety of esthetic feelings of users.

### TECHNICAL FIELD

The present invention relates to a refrigerator, and more particularly, to an outer door for defining a front surface of a door of a refrigerator and a method of manufacturing the outer door.

### BACKGROUND ART

FIG. 1 shows a portion of a conventional door of a refrigerator, and FIG. 2 enlargedly shows a portion of an outer door shown in FIG. 1.

As shown in the figures, a door liner 20 is coupled to a rear portion of the outer door 10 for defining a front surface of the door 1 of the refrigerator. A foaming liquid is filled in a space between the outer door 10 and the door liner 20 and the filled foaming liquid is solidified to form an insulating layer 30, thereby manufacturing the door 1.

Meanwhile, as shown in FIG. 2, a base plate 11 constructing the outer door 10 is formed of an iron plate. The base plate 11 has a thickness of about 3 to 10 mm.

Further, a back surface coating layer 13 is provided on a back surface of the base plate 11, which corresponds to an inner surface of the outer door 10. The coating layer 13 functions to remove various kinds of contaminants, such as dust or rust due to corrosion, on the back surface of the base plate 11. The coating layer 13 is formed by applying a phosphate with a thickness of about 50 Nm on the back surface of the base plate 11.

A back surface painting layer 15 is provided on a surface of the back surface coating layer 13. The back surface painting layer 15 is formed by applying paint with a thickness of about 20 μm on the surface of the back surface coating layer 13. The back surface painting layer 15 is to protect the back surface of the base plate 11. The back surface painting layer 15 is substantially in contact with the insulating layer 30 so as to allow the outer door 10 and the insulting layer 30 to be easily detached from each other when the door 1 is discarded.

Meanwhile, a front surface painting layer 17 is provided on a front surface of the base plate 11. The front surface painting layer 17 functions to protect the front surface of the base plate 11 and includes a first front surface painting layer 17a and a second front surface painting layer 17b.

The first front surface painting layer 17a is formed by applying paint with a thickness of about 50 μm on the front surface of the base plate 11, and the second front surface painting layer 17b is formed by applying paint with a thickness of about 20 to 25 μm on a surface of the first front surface painting layer 17a. Therefore, since the second front surface painting layer 17b is substantially exposed outward, paint with a certain color is preferably used as the paint for forming the second front surface painting layer 17b. On the contrary, the first front surface painting layer 17a is formed of colorless paint so that the color of the second front surface painting layer 17b can be implemented more clearly.

Moreover, a protective vinyl layer 19 is provided on a surface of the second front surface painting layer 17b. The protective vinyl layer 19 is made of a transparent or translucent material with a thickness of about 50 to 100 μm and attached to the surface of the second front surface painting layer 17b. The protective vinyl layer 19 functions to protect the second front surface painting layer 17b.

However, the conventional outer door for a refrigerator constructed as such has the following problems.

Since the base plate 1 is formed of an iron plate as described above, a particular design cannot be expressed on a front surface of the outer door 10 but only the second front surface painting layer 17 with a certain color is represented outward. Thus, although it is possible to change the color of the front surface of the outer door 10 depending on a selection of paint forming the second front surface painting layer 17b, it is impossible to design a variety of patterns or shapes on the front surface of the outer door 10.

### DISCLOSURE

### [Technical Problem]

The present invention is conceived to solve the aforementioned problems in the prior art. An object of the present invention is to provide an outer door for a refrigerator, which is constructed such that more various designs can be implemented thereon, and a method of manufacturing the outer door.

### [Teclmical Solution]

According to an aspect of the present invention for achieving the object, there is provided an outer door for a refrigerator, comprising a base plate with a certain pattern formed on a front surface thereof; a back surface coating layer provided on a back surface of the base plate; a back surface painting layer provided on a surface of the back surface coating layer; and a front surface painting layer provided on the front surface of the base plate.

The pattern of the base plate may be formed by rolling the base plate using a rolling roller having convexo-concave portions provided on an outer periphery thereof such that the front surface of the base plate is pressed by the convexo-concave portions of the rolling roller.

The front surface painting layer may comprise a first front surface painting layer formed by applying paint on the front surface of the base plate; and a second front surface painting layer formed by applying paint on a surface of the first front surface painting layer.

The front surface painting layer may further comprise a third front surface painting layer formed by applying paint on a surface of the second front surface painting layer.

The first and third front surface painting layers may be formed by applying transparent colorless paint, and the second front surface painting layer may be formed by applying paint with a certain color.

The outer door may further comprise a protective vinyl layer attached to a surface of the third front surface painting layer.

According to another aspect of the present invention, there is provided a method of manufacturing an outer door for a refrigerator, comprising the steps of: (a) forming a certain pattern on a front surface of a base plate; (b) providing a back surface coating layer on a back surface of the base plate; (c) providing a back surface painting layer on a surface of the back surface coating layer; and (d) providing a front surface painting layer on the front surface of the base plate.

In step (a), the pattern of the base plate may be formed by rolling the base plate using a rolling roller with convexo-concave portions provided on an outer periphery thereof such that the front surface of the base plate is pressed by the convexo-concave portions of the rolling roller.

Step (d) may comprise the steps of, (d1) providing a first front surface painting layer formed by applying transparent colorless paint on the front surface of the base plate; and (d2) providing a second front surface painting layer formed by applying paint with a certain color on a surface of the first front surface painting layer.

The method may further comprise the step of: (e) attaching a protective vinyl layer to a surface of the second front surface painting layer.

According to a further aspect of the present invention, there is provided a method of manufacturing an outer door for a refrigerator, comprising the steps of: (a) providing a back surface coating layer on a back surface of a base plate; (b) providing a back surface painting layer on a surface of the back surface coating layer; (c) providing a front surface painting layer on a front surface of the base plate; and (d) forming a certain pattern on the front surface of the base plate.

In step (d), the pattern of the base plate may be formed by rolling the base plate using a rolling roller with convexo-concave portions provided on an outer periphery thereof such that the front surface of the base plate is pressed by the convexo-concave portions of the rolling roller.

Step (c) may comprise the steps of: (c1) providing a first front surface painting layer formed by applying transparent colorless paint on the front surface of the base plate; and (c2) providing a second front surface painting layer formed by applying paint with a certain color on a surface of the first front surface painting layer.

The method may further comprise the step of: (e) providing a third front surface painting layer formed by applying transparent colorless paint on a surface of the second front surface painting layer.

The method may further comprise the step of: (f) attaching a protective vinyl layer to a surface of the third front surface painting layer.

According to the present invention, more various designs can be implemented on the front surface of the door of the refligerator so as to satisfy a variety of esthetic feelings of users.

### [Advantageous Effects]

With the outer door for a refrigerator and the method of manufacturing the same according to the present invention constructed as above, a certain pattern can be formed on a front surface of a base plate of the outer door, Thus, it is expected to obtain an effect by which a refrigerator door with various designs capable of satisfying esthetic demands of users can be manufactured.

### DESCRIPTION OF DRAWINGS

FIG. 1 is a sectional side view showing a portion of a conventional door for a refrigerator.

FIG. 2 is an enlarged view showing a portion of an outer door shown in FIG. 1.

FIG. 3 is a sectional side view showing a main portion of an outer door for a refrigerator according to a preferred embodiment of the present invention.

FIGS. 4 to 9 are views showing processes of manufacturing the outer door for a refrigerator by means of a method of manufacturing the outer door according to a preferred embodiment of the present invention.

FIG. 10 is a sectional side view showing a main portion of an outer door for a refrigerator according to another preferred embodiment of the present invention.

### BEST MODE

Hereinafter, preferred embodiments of an outer door for a refrigerator and a method of manufacturing the same according to the present invention will be described in detail with reference to the accompanying drawings.

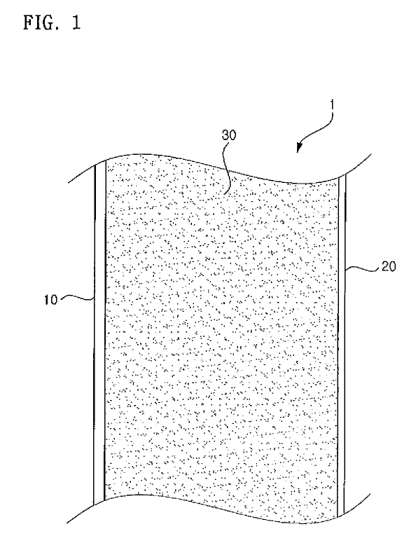

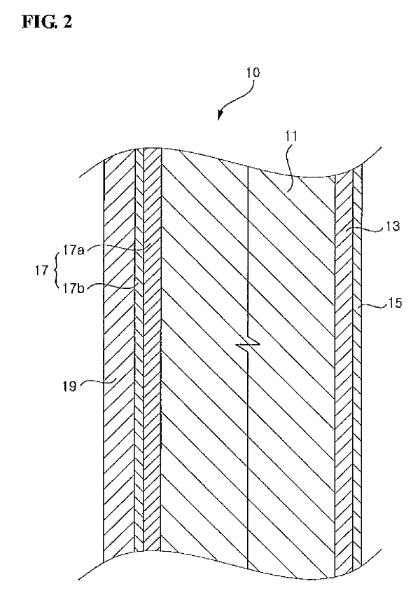

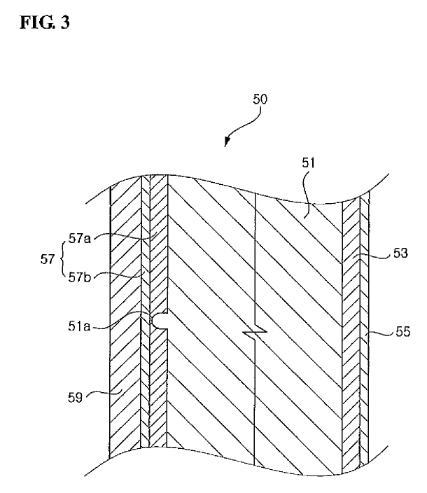

FIG. 3 shows an outer door for a refrigerator according to a preferred embodiment of the present invention. Components identical with those of a conventional outer door for a refrigerator will be described by citing reference numerals denoted in FIG. 1.

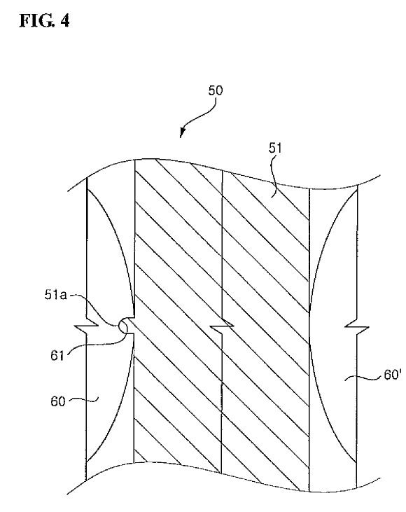

As shown in the figure, a base plate 51 of an outer door 50 for defining a front surface of a refrigerator door is formed of an iron plate with a thickness of about 3 to 10 mm. Then, a predetermined pattern 51a is formed on a front surface of the outer door 50. The pattern 51a of the base plate 51 is formed by rolling the base plate 51 using rolling rollers 60 and 60′ (see FIG. 4) such that a front surface of the base plate 51 is pressed by convexo-concave portions 61 provided on an outer periphery of the rolling roller 60 of the rollers 60 and 60′, which is brought into close contact with the front surface of the base plate 51.

For example, if the convexo-concave portions 61 of the rolling roller 60 are in the form of waves, a wavy pattern 51a is formed on the front surface of the base plate 51. At this time, the pattern 51a of the base plate 51 has a thickness determined in consideration of the thickness of the base plate 51. The pattern is preferably formed to have a thickness relatively smaller than the thickness of a first front surface painting layer 57a that will be described below.

A back surface coating layer 53 is provided on a back surface of the base plate 51. The back surface coating layer 53 is formed by applying a phosphate with a thickness of about 50 μm on the back surface of the base plate 51. The back surface coating layer 53 is to remove various kinds of contaminants, such as dust or rust due to corrosion, on the back surface of the base plate 51.

A back surface painting layer 55 is provided on a surface of the back surface coating layer 53. The back surface painting layer 55 functions to protect the back surface of the base plate 51. The back surface painting layer 55 is formed by applying paint with a thickness of about 20 μm on the surface of the back surface coating layer 53.

A front surface painting layer 57 is provided on the front surface of the base plate 51. The front surface painting layer 57 protects the front surface of the base plate 51, and at the same time, substantially forms the front surface of the outer door 50 so as to represent a color to the outside. The front surface painting layer 57 includes a first front surface painting layer 57a and a second front surface painting layer 57b.

The first front surface painting layer 57a is formed by applying paint with a thickness of about 50 μm on the front surface of the base plate 51. The second front surface painting layer 57b is formed by applying paint with a thickness of about 20 to 25 μm on a surface of the first front surface painting layer 57a. The paint for forming the first front surface painting layer 57a is transparent colorless paint, and the second front surface painting layer 57b is formed of paint with a certain color.

Moreover, a protective vinyl layer 59 is provided on a surface of the second front surface painting layer 57b. The protective vinyl layer 59 functions to protect the second front surface painting layer 57b. The protective vinyl layer 59 is formed of a transparent or translucent vinyl sheet with a thickness of about 50 to 100 μm and attached to the surface of the second front surface painting layer 57b.

Next, a method of manufacturing the outer door for a refrigerator according to a preferred embodiment of the present invention will be described in detail with reference to the accompanying drawings.

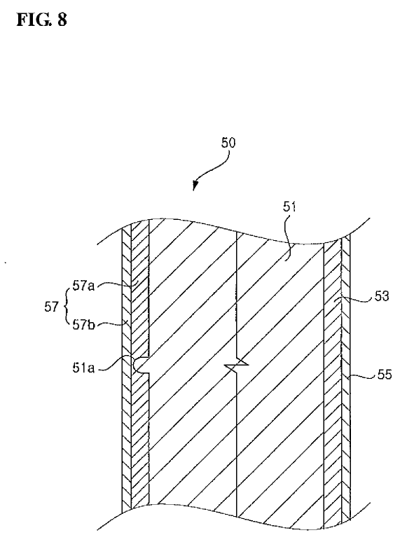

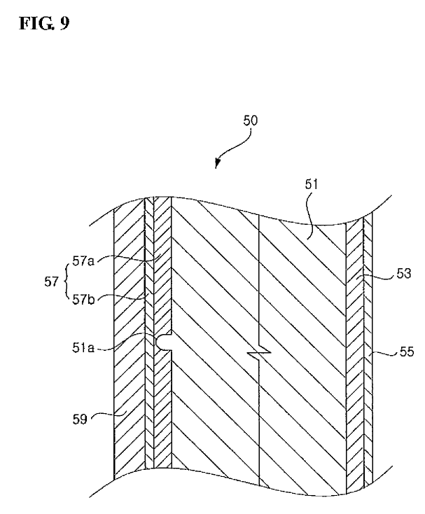

FIGS. 4 to 9 show processes of manufacturing the outer door for a refrigerator by means of a method of manufacturing the outer door according to a preferred embodiment of the present invention.

As shown in FIG. 4, the base plate 51 is first rolled while being passed between the rolling rollers 60 and 60′, so that the pattern 51a is formed on the front surface of the base plate 51.

The pattern 51a of the base plate 51 is formed in such a manner that the front surface of the base plate 51 is pressed by the convexo-concave portions 61 provided on the outer periphery of the rolling roller 60 of the rollers 60 and 60′, which is brought into close contact with the front surface of the base plate 51.

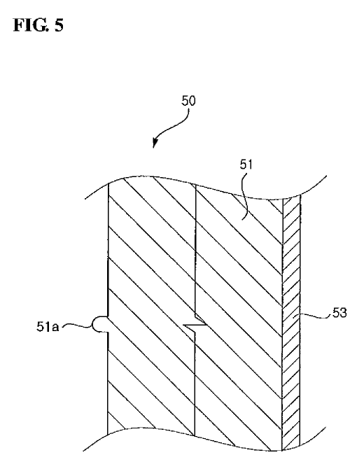

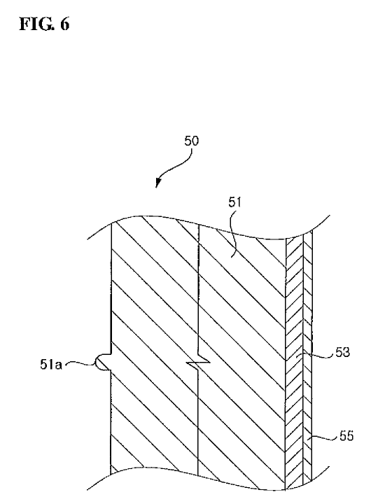

In a state where the pattern 51 a has been formed on the front surface of the base plate 51, a phosphate is applied with a thickness of about 50 μm on the back surface of the base plate 51 to form the back surface coating layer 53, as shown in FIG. 5. Then, as shown in FIG. 6, paint is applied again with a thickness of about 20 μm on a surface of the back surface coating layer 53 to form the back surface painting layer 55.

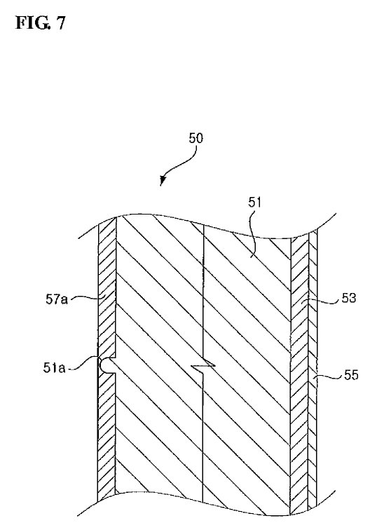

Then, as shown in FIG. 7, transparent colorless paint is applied with a thickness of about 50 μm on the front surface of the base plate 51 to form the first front surface painting layer 57a. Paint with a certain color is applied with a thickness of about 20 to 25 μm on a surface of the first front surface painting layer 57a to form the second front surface painting layer 57b.

Finally, the protective vinyl layer 59 that is a vinyl sheet with a thickness of about 50 to 100 μm is attached to a surface of the second front surface painting layer 57b, thereby completing the manufacture of the outer door 50. Then, a door liner is coupled to a rear side of the outer door 50 manufactured as above, and a foaming liquid is filled and solidified in a space between the outer door 50 and the door liner to form an insulating layer, thereby completing the manufacture of the refrigerator door 1.

Hereinafter, an outer door for a refrigerator according to another embodiment of the present invention will be described with reference to the accompanying drawing.

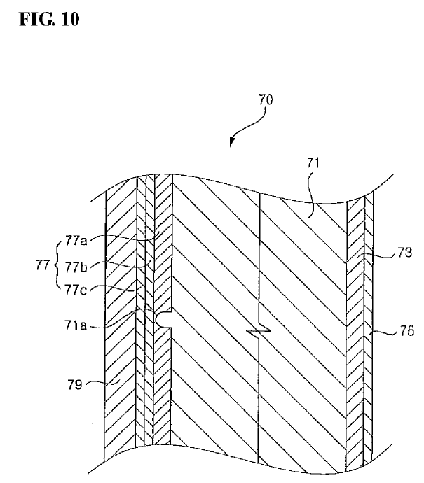

FIG. 10 shows the outer door for a refrigerator according to the other embodiment of the present invention.

As shown in the figure, a back surface coating layer 73 and a back surface painting layer 75 are sequentially provided on a back surface of a base plate 71 of the outer door 70. Moreover, first and second front surface painting layers 77a and 77b are provided on a front surface of the base plate 71. Such structures are the same as the embodiment shown in FIG. 3.

In this embodiment, however, a third front surface painting layer 77c is further provided on a surface of the second front surface painting layer 77b. That is, a front surface painting layer 77 provided on the front surface of the base plate 71 includes the first to third front surface painting layers 77a to 77c. This is because a pattern 71a is formed on the front surface of the base plate 71 in a state where the first and second front surface painting layers 77a and 77b have been provided on the front surface of the base plate 71.

In other words, since the pattern 71a is formed by rolling the base plate 71 using the rolling rollers 60 and 60′ (see FIG. 4) such that the front surface of the base plate 71 is pressed by the convexo-concave portions 61 provided on the outer periphery of the rolling roller 60 of the rollers 60 and 60′, which is brought into close contact with the front surface of the base plate 71, a crack or scratch may be created in the first and second front surface painting layers 77a and 77b. Thus, contrary to the embodiment shown in FIG. 3, the third front surface painting layer 77c is provided on the surface of the second front surface painting layer 77b, thereby reinforcing a crack or scratch described above.

The third front surface painting layer 77c is formed by applying paint with a thickness of about 5 to 20 μm on the surface of the second front surface painting layer 77b. The paint for forming the third front surface painting layer 77c is transparent colorless paint for enabling the color of the second front surface painting layer 77b to be represented to the outside.

The scope of the present invention is not limited to the aforementioned embodiments but defined by the appended claims. It will be apparent that those skilled in the art can make various modifications and adaptations within the scope of the invention defined by the claims.

1. An outer door for a refrigerator, comprising:
a base plate with a certain pattern formed on a front surface thereof;
a back surface coating layer provided on a back surface of the base plate;
a back surface painting layer provided on a surface of the back surface coating layer; and
a front surface painting layer provided on the front surface of the base plate,

2. The outer door as claimed in claim 1, wherein the pattern of the base plate is formed by rolling the base plate using a rolling roller having convexo-concave portions provided on an outer periphery thereof such that the front surface of the base plate is pressed by the convexo-concave portions of the rolling roller.

3. The outer door as claimed in claim 1 or 2, wherein the front surface painting layer comprises:
a first front surface painting layer formed by applying paint on the front surface of the base plate; and
a second front surface painting layer formed by applying paint on a surface of the first front surface painting layer.

4. The outer door as claimed in claim 3, wherein the front surface painting layer further comprises a third front surface painting layer formed by applying paint on a surface of the second front surface painting layer.

5. The outer door as claimed in claim 4, wherein the first and third front surface painting layers are formed by applying transparent colorless paint, and the second front surface painting layer is formed by applying paint with a certain color.

6. The outer door as claimed in claim 5, fiuther comprising a protective vinyl layer attached to a surface of the third front surface painting layer.

7. A method of manufacturing an outer door for a refrigerator, comprising the steps of:
(a) forming a certain pattern on a front surface of a base plate;
(b) providing a back surface coating layer on a back surface of the base plate;
(c) providing a back surface painting layer on a surface of the back surface coating layer; and
(d) providing a front surface painting layer on the front surface of the base plate.

8. The method as claimed in claim 7, wherein in said step (a), the pattern of the base plate is formed by rolling the base plate using a rolling roller with convexo-concave portions provided on an outer periphery thereof such that the front surface of the base plate is pressed by the convexo-concave portions of the rolling roller.

9. The method as claimed in claim 7 or 8, wherein said step (d) comprises the steps of:
(d1) providing a first front surface painting layer formed by applying transparent colorless paint on the front surface of the base plate; and
(d2) providing a second front surface painting layer formed by applying paint with a certain color on a surface of the first front surface painting layer.

10. The method as claimed in claim 9, further comprising the step of:
(e) attaching a protective vinyl layer to a surface of the second front surface painting layer.

11. A method of manufacturing an outer door for a refrigerator, comprising the steps of:
(a) providing a back surface coating layer on a back surface of a base plate;
(b) providing a back surface painting layer on a surface of the back surface coating layer;
(c) providing a front surface painting layer on a front surface of the base plate; and
(d) forming a certain pattern on the front surface of the base plate.

12. The method as claimed in claim 11, wherein in said step (d), the pattern of the base plate is formed by rolling the base plate using a rolling roller with convexo-concave portions provided on an outer periphery thereof such that the front surface of the base plate is pressed by the convexo-concave portions of the rolling roller.

13. The method as claimed in claim 11 or 12, wherein said step (c) comprises the steps of:
(c1) providing a first front surface painting layer formed by applying transparent colorless paint on the front surface of the base plate; and
(c2) providing a second front surface painting layer formed by applying paint with a certain color on a surface of the first front surface painting layer.

14. The method as claimed in claim 13, further comprising the step of:
(e) providing a third front surface painting layer formed by applying transparent colorless paint on a surface of the second front surface painting layer.

15. The method as claimed in claim 14, further comprising the step of:
(f) attaching a protective vinyl layer to a surface of the third front surface painting layer.
